(19) United States
(12) Patent Application Publication
(10) Pub. No.: US 2021/0179243 A1
(43) Pub. Date: Jun. 17, 2021

(54) CURRENT POWER ENERGY SYSTEMS

(71) Applicant: Current Power Energy Systems, Inc., Del Mar, CA (US)

(72) Inventors: Frank J. TYBOR, Solana Beach, CA (US); Joseph MARKEE, Del Mar, CA (US)

(73) Assignee: Current Power Energy Systems, Inc., Del Mar, CA (US)

(21) Appl. No.: 16/713,875

(22) Filed: Dec. 13, 2019

(51) Int. Cl. B63H 19/04; B63H 5/07; B63H 21/17

(52) U.S. Cl. CPC B63H 19/04; B63B 2209/14; B63H 21/17; B63H 5/07

(57) ABSTRACT

A submersible device is provided herein. The submersible device may include a submersible hull, control fins, propeller fins, and a turbine device. The submersible hull may include a proximal end, an opposing distal end, a first sidewall and a second sidewall opposite the first sidewall. The sidewalls may be in between the proximal and distal ends of the hull. The control fins may extend from the submersible hull. At least one control fin extends from the first sidewall and at least one other control fin extends from the second sidewall. The propeller fins may extend from the submersible hull at the distal end. Each of the propeller fins may be connected to a rotor. The turbine device may be communicatively coupled to the rotor.

### BACKGROUND

Embodiments disclosed herein relate to a submersible device. More specifically, embodiments disclosed herein are directed towards a submersible device that may be able to generate electricity from the kinetic energy resulting from ocean currents.

Developed and developing countries have a huge need for energy that continues to grow. Various energy sources are exploited to supply this need: 1) Fossil fuels including oil, natural gas and coal; 2) Hydroelectric in the form of dams (gravity based water power); 3) Nuclear; 4) Geothermal; 5) Solar thermal (steam generation to power generators); 6) Solar photovoltaic (solar panels); 7) Wind power on land and offshore; and 8) Tidal currents.

Excluding fossil fuel, which is generally used by internal combustion engines for transportation, these energy sources are converted into electrical power using appropriate technology. The electrical power produced is typically fed into an electrical grid for distribution to users—consumer and commercial.

These energy sources are generally grouped by their environmental impact into polluting and green, and by their longevity into renewable and non-renewable. The green grouping is easy to discern because there is no CO₂ released in the process while the renewable grouping includes everything that is not immediately finite in supply such as oil, gas and coal. The only difficult source to categorize is nuclear, which does not produce CO₂, but rather produces dangerous radioactive waste. Furthermore, nuclear sources rely on somewhat finite supply of uranium (somewhere between fossil fuels and the sun). In addition, nuclear has a well-known operational safety problem. Finally, these sources can be grouped into constant (7×24×365) supply (known as base-load) and intermittent supply.

Historically, fossil fuels, hydroelectric and nuclear have been the mainstay sources of electrical power energy sources with the remainder relegated to niche participation. That dynamic is changing due to several factors: 1) Intense suspicion of nuclear due to reactor failures and long term waste storage; 2) Recognition of the environmental damage resulting from fossil fuel use; 3) Recognition that fossil fuels are finite in supply and are subject to geopolitical supply disruption; 4) Dramatic cost decreases and efficiency increases in photovoltaic systems (solar cells) resulting in strong residential and commercial growth; and 5) Dramatic engineering improvements in wind powered generation systems resulting in strong commercial growth.

Public opinion and governmental support via subsidies, rebates and preferential licensing has propelled green, renewable electrical power generation worldwide. On shore and off-shore wind power and tidal currents are recognized as green, renewable electrical power generation sources.

Kinetic energy may be derived from general movement of the ocean. For example, surface level movement of the ocean may translate to wave energy. As generally understood, wave energy is extracted from either the up/down surface motion or back and forth surface motion of the fluid. The particles of the fluid do not have significant bulk motion.

Tidal currents are found in shallow waters, typically near the shore. Tides are generally provided in ebbs and flows. Unlike wave energy, the overall bulk motion of the fluid is generally used to create energy via a turbine or other means. Systems configured to capture tidal currents are limited to areas with tidal flows. These systems are typically sub-sea mounted, and thus cannot be implemented in significant water depth.

Ocean currents are an attractive source of renewable energy. Off-shore, deep water currents represent a huge, steady source of energy. For example, scientists estimate the ocean currents off the Atlantic Coast of North America can generate upwards of 300 Giga Watts (60% of Average US Demand). Ocean current energy is abundant, well distributed around the globe, and near much of the world's population. Ocean energy is also more constant than wind and solar energy. Moreover, current energy has a higher utilization than solar, wind, wave energy, off-shore wind, and tidal energy. Nonetheless, little use has been made of ocean current energy due to the difficulties in converting that energy into a useful form, such as electricity, the difficulties in operating economically in a deep ocean environment, and the difficulties of conveying generated power to the mainland.

Most conventional technologies relating to generating electricity from the ocean focus on extracting ocean wave energy from the motion of the ocean surface as they migrate through the energy generating device. Specifically, conventional technologies focus on extracting ocean wave energy by either using moving flows or using wind turbines driven by air trapped in enclosures above the waves. Additionally, subsurface technologies are used to generate electricity from the ebb and flow for currents created by the ebb and flow of tides. However, these conventional technologies are inefficient because of the variability of the ocean flows.

Accordingly, there is a need and desire for a device that can generate constant electricity from steady, ocean currents. Such a device would be a submersible generator located in the areas of the ocean where constant currents exist.

### SUMMARY

A submersible device may be provided herein. The submersible device may include a submersible hull, a plurality of control fins, a plurality of propeller fins, and a turbine device. The submersible hull may include a proximal end, an opposing distal end, a first sidewall and a second sidewall opposite the first sidewall. The sidewalls are in between the proximal and distal ends of the hull. The plurality of control fins may extend from the submersible hull. In some embodiments, at least one control fin extends from the first sidewall and at least one other control fin extends from the second sidewall. The plurality of propeller fins may extend from the submersible hull at the distal end. In some embodiments, each of the propeller fins may be connected to a rotor and the turbine device may be communicatively coupled to the rotor.

In some embodiments, the turbine device may be configured to generate electricity due to rotation of the plurality of propeller fins. The submersible device may further include a power conditioning device communicatively coupled to the turbine device and electrically connected to an electric grid. In some embodiments, the power conditioning device may be configured to output the electricity to the electrical grid via interconnect adaptors. The interconnect adaptor may be closer to the proximal end than the distal end. The power conditioning device may also include a tethering device configured to secure the power conditioning device to a sub-surface.

In some embodiments, the rotation of the plurality of propeller fins corresponds with the motion of ocean currents. The submersible device may further include an active and passive control system communicatively coupled to the plurality of control fins and the plurality of propeller fins. The active and passive control system may be configured to maintain depth, position and orientation of the submersible hull.

In some embodiments, the active and passive control system may be configured to nullify torque at the distal end of the submersible hull. Furthermore, the active and passive control system may also be configured to produce a positive swirl of water at the plurality of propeller fins. The active and passive control system may be configured to cause the submersible hull to move side to side creating a large sway area. In some embodiments, each propeller fin of the plurality of propeller fins is foldable. The internal volume of the submersible hull may be pressure compensated at a controlled pressure other than ambient pressure.

A system may also be provided. The system may include a moored substation and two or more submersible power generators electrically coupled to the moored substation. Each submersible power generator may include a submersible hull, a plurality of control fins, a plurality of propeller fins, a turbine device, and a power conditioning device. The submersible hull may include a proximal end, an opposing distal end, a first sidewall and a second sidewall opposite the first sidewall. The sidewalls may be between the proximal and distal ends of the hull.

In some embodiments of the system, the plurality of control fins may extend from the submersible hull. At least one control fin may extend from the first sidewall and at least one other control fin may extend from the second sidewall. The plurality of propeller fins may extend from the submersible hull at the distal end, in the system. In some embodiments of the system, each of the propeller fins may be connected to a rotor. The turbine device may be communicatively coupled to the rotor. In some embodiments of the system, the power conditioning device may be communicatively coupled to the turbine device and electrically connected to moored substation.

In some embodiments of the system, the turbine device may be configured to generate electricity due to rotation of the plurality of propeller fins. The submersible device may further include a power conditioning device communicatively coupled to the turbine device and electrically connected to an electric grid. In some embodiments of the system, the power conditioning device may be configured to output the electricity to the electrical grid via an interconnect adaptor. The interconnect adaptor may be closer to the proximal end than the distal end. The power conditioning device may also include a tethering device configured to secure the power conditioning device to a sub-surface.

In some embodiments of the system, the rotation of the plurality of propeller fins corresponds with the motion of ocean currents. The submersible device may further include an active and passive control system communicatively coupled to the plurality of control fins and the plurality of propeller fins. The active and passive control system may be configured to maintain depth, position and orientation of the submersible hull.

In some embodiments, the active and passive control system may be configured to manipulate the plurality of control fins and the plurality of propeller fins to nullify torque at the distal end of the submersible hull. Furthermore, the active and passive control system may also be configured to manipulate the plurality of control fins and the plurality of propeller fins to produce a positive swirl of water at the plurality of propeller fins. The active and passive control system may be configured to manipulate the plurality of control fins and the plurality of propeller fins to cause the submersible hull to move side to side creating a large sway area. In some embodiments, each propeller of the plurality of propeller fins is foldable. An internal volume of the submersible hull may be pressure compensated at a controlled pressure other than ambient pressure.

A moored substation may also be provided. The moored substation may include a submersible hull with a proximal end, an opposing distal end, a first sidewall and a second sidewall opposite the first sidewall, said sidewalls being between the proximal and distal ends of the hull. The submersible hull may also include a plurality of control fins extending from the submersible hull. At least one control fin can extend from the first sidewall and at least one other control fin can extend from the second sidewall. The moored substation may also include a power conditioner device configured to receive power from at least one submersible power generator and output the electricity to an electrical grid. The submersible device can also include a fairing extending from the submersible hull at the distal end.

A system may also be provided. The system may include a first plurality of submersible power generators arranged in a first row and positioned at a first depth. The system may also include a second plurality of submersible power generators arranged in a second row positioned at a second depth behind the first plurality of submersible power generators. The second depth may be different from the first depth.

Additional features and advantages of the disclosure will be set forth in the description that follows, and in part, will be obvious from the description; or can be learned by practice of the principles disclosed herein. The features and advantages of the disclosure can be realized and obtained by means of the instruments and combinations particularly pointed out in the appended claims. These and other features of the disclosure will become fully apparent from the following description and appended claims or can be learned by the practice of the principles set forth herein.

### BRIEF DESCRIPTION OF THE DRAWINGS

In order to describe the manner in which the above-recited and other advantages and features of the disclosure can be obtained, a more particular description of the principles described above will be rendered by reference to specific examples illustrated in the appended drawings. These drawings depict only example aspects of the disclosure and are therefore not to be considered as limiting of its scope. The principles are described and explained with additional specificity and detail through the use of the following drawings.

FIG. 1 is a front isometric view of an example submersible device, in accordance with an embodiment of the present disclosure.

FIG. 2 is a side plan view of the example submersible device of FIG. 1, in accordance with an embodiment of the present disclosure.

FIG. 3 is a top plan view of the example submersible device of FIG. 1, in accordance with an embodiment of the present disclosure.

FIG. 4 is a block diagram illustrating example components of the submersible device of FIG. 1, in accordance with an embodiment of the present disclosure.

FIG. 5 illustrates an example electrical interconnect system, in accordance with an embodiment of the present disclosure.

FIG. 6 is a front isometric view of a moored substation, in accordance with an embodiment of the present disclosure.

FIG. 7 is a side plan view of the moored substation of FIG. 6, in accordance with an embodiment of the present disclosure.

FIG. 8 is a block diagram illustrating example components of the moored substation of FIG. 6, in accordance with an embodiment of the present disclosure.

FIG. 9 illustrates more than one submersible device of FIG. 1 in an ocean environment, in accordance with an embodiment of the present disclosure.

FIG. 10 illustrates a side plan of the electrical interconnect system of FIG. 9, in accordance with an embodiment of the present disclosure.

FIG. 11 illustrates more than one submersible device and ocean current flow, in accordance with an embodiment of the present disclosure.

### DETAILED DESCRIPTION OF THE PREFERRED EMBODIMENTS

A submersible device is provided herein. The submersible device may include a submersible hull, control fins, propeller fins, and a turbine device. The submersible hull may include a proximal end, an opposing distal end, a first sidewall and a second sidewall opposite the first sidewall. The sidewalls may be between the proximal and distal ends of the hull. The control fins may extend from the submersible hull. At least one control fin may extend from the first sidewall and at least one other control fin may extend from the second sidewall. The propeller fins may extend from the submersible hull at the distal end. Each of the propeller fins may be connected to a rotor. The turbine device may be communicatively coupled to the rotor.

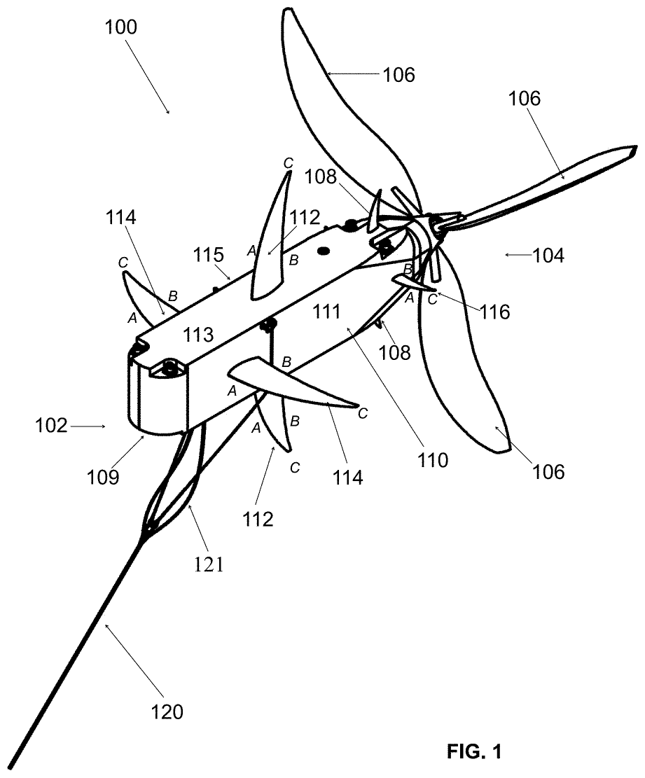

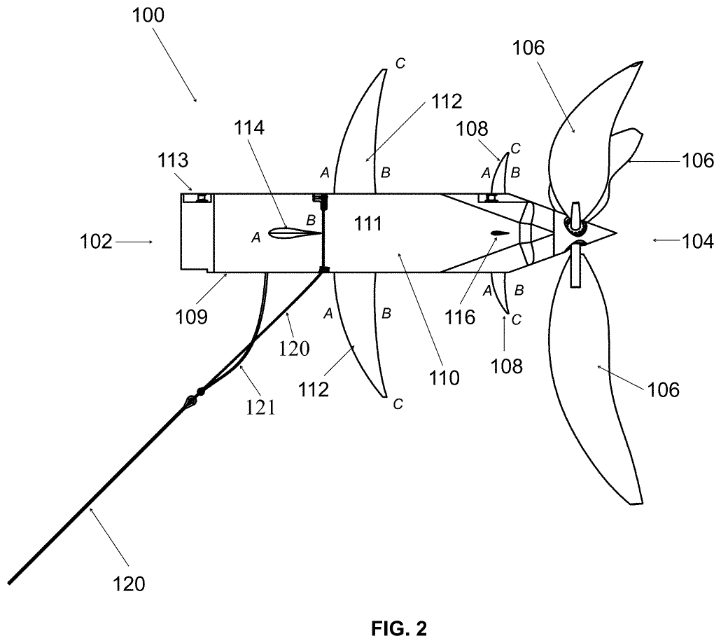

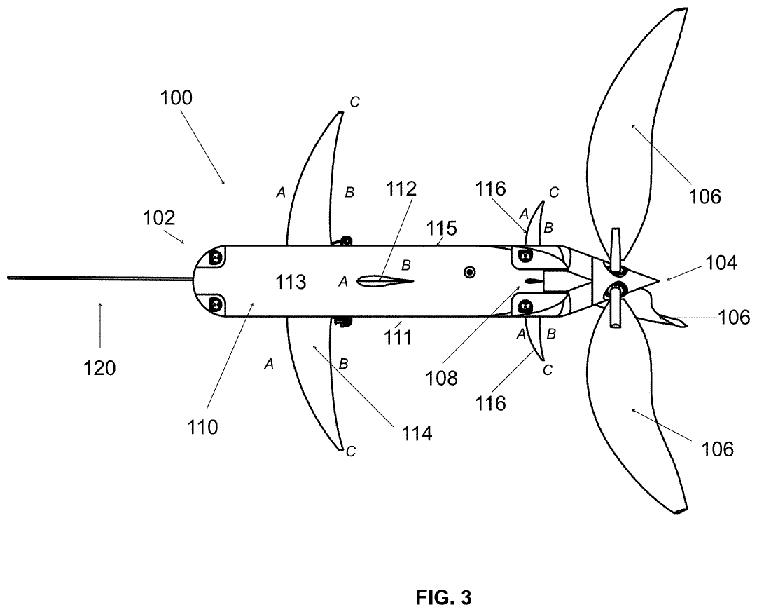

FIG. 1 illustrates an example submersible device 100, in accordance with an embodiment of the present disclosure. FIG. 2 is a side plan view of the submersible device 100, and FIG. 3 is a top plan view of the of the submersible device 100. The submersible device 100 can include a proximal end 102 and a distal end 104. The submersible device 100 can also include a submersible hull 110, control fins 112, 114, 108, and 116, sidewalls 109, 111, 113, and 115, and propeller fins 106. The submersible device 100 may be secured to the ocean floor, or to another device beneath the submersible device 100 by a tethering device 120. The submersible device 100 may be configured to output electricity to an electrical grid (not shown) via an interconnect adaptor 121, running along the tethering device 120. The submersible hull 110 may be an elongated structural body, tapering towards the distal end 104, for enhanced aerodynamic characteristics.

Furthermore, an internal volume of the submersible hull 110 may be pressure compensated at a controlled pressure other than ambient pressure. In this way, the hull thickness can be reduced compared to traditional submersible devices. In one or more embodiments, the hull thickness may be between ¼ inch and ½ inch, consistent with standard barge-construction. A pressure hull of equivalent diving depth would typically be between 1 inch and 1½ inches. This enables efficient and economical manufacturing, shipping and handling of the submersible hull 110, the control fins 112, 114, 108, and 116, and propeller fins 106. In some embodiments, the submersible hull 110 may be configured with flat steel sections, greatly simplifying manufacturing and improving efficiency. Furthermore, the submersible hull 110 may be positively buoyant and negatively buoyant. In the event the submersible device 100 becomes untethered from the ocean floor, the submersible device 100 will float to the ocean surface for retrieval and maintenance.

The control fins can include lateral control fins 114 and 116, and vertical control fins 112 and 108. The lateral control fins 116 and the vertical control fins 108 can be positioned on the submersible hull 110 towards the distal end 104. The lateral control fins 114 and the vertical fins 112 can be positioned on the submersible hull 110 towards the proximal end 102. The lateral control fins 116 and the vertical fins 108 can be smaller in size compared to the lateral control fins 114 and the vertical fins 112. The number and orientation of control fins are provided herein for exemplary purposes. That is, the exemplary submersible device 100 can include more or less control fins and more or less propeller fins. Each of the control fins can extend from the submersible hull 110 and be oriented in various configurations, including but not limited to the orientations shown in the illustrated embodiment.

In some embodiments, the lateral control fins 114 and 116, and vertical control fins 112 and 108 are operable to adjust their orientation on the submersible hull 110. For example, each of the lateral control fins 114 and 116 can include a leading-edge A, a trailing edge B, and a wingtip C adjoining the leading-edge A and the trailing edge B. The lateral control fins 114 and 116 can be operable such that trailing edge B may be rotated towards sidewall 113 or sidewall 109.

Similarly, each of the vertical control fins 112 and 108 can include a leading-edge A, a trailing edge B, and a wingtip C adjoining the leading-edge A and the trailing edge B. The vertical control fins 112 and 108 can be operable such that trailing edge B may be rotated towards sidewall 111 or sidewall 115. The lateral control fins 114 and 116, and the vertical control fins 112 and 108 may be curved fluidic elements adapted to harness power from an incoming ocean current.

The propeller fins 106 may extend from the submersible hull 110 at the distal end 104. The propeller fins 106 may be detachable from the submersible hull 110. In some embodiments, the propeller fins 106 are foldable to minimize the costs associated with shipping and handling. In some embodiments, each of the propeller fins 106 may be connected to a rotor (e.g., rotor 250 shown in FIG. 5).

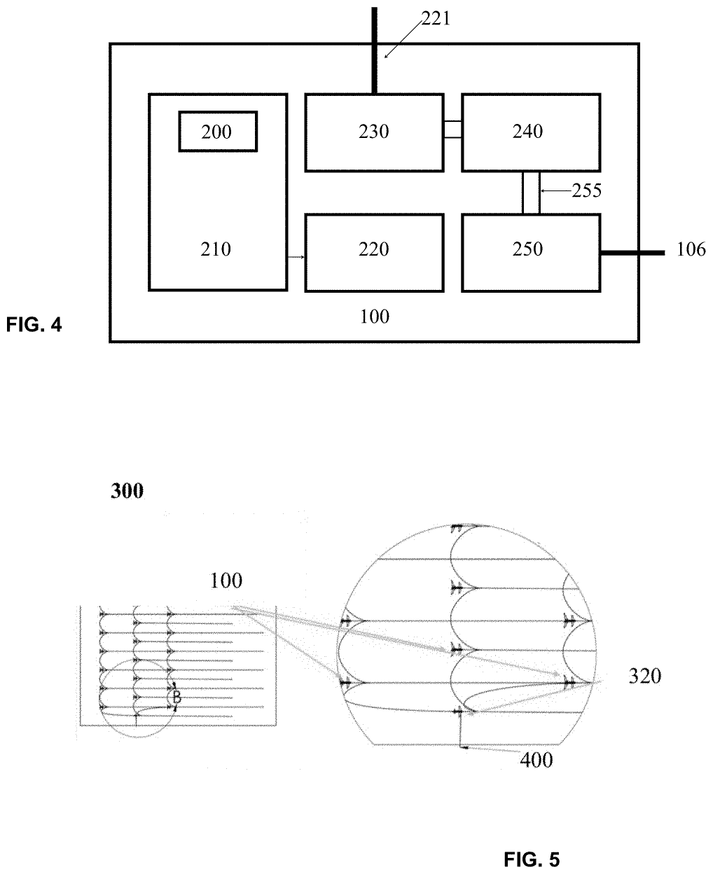

FIG. 4 is a block diagram illustrating example components of the submersible device 100, in accordance with an embodiment of the present disclosure. The submersible device 100 may include a wet room 210, an electrical housing 220 for electrical cable connections, a power conditioning device 230, a turbine device 240, and a rotor 250. The propeller fins 106 can be coupled to the rotor 250, which may have a shaft 255 in communication with the turbine device 240. The rotation of the propeller fins 106 may cause the rotor 250, and subsequently the shaft 255 to rotate.

The rotation of the rotor 250 and the shaft 255 may cause the turbine device 240 to generate electricity. In other words, the turbine device 240 may be configured to generate electricity due to rotation of the propeller fins 106. The power conditioning device 230 may be communicatively coupled to the turbine device 240. The wet room 210 can house a control system 200.

The control system 200 and other electrical components within the wet room 210 can be electrically coupled to the electrical housing 220. The power conditioning device 230 may be configured to output electricity to an electrical grid (not shown) via an interconnect adaptor 221. The interconnect adaptor 221 may be coupled to the electrical housing 220.

The control system 200 can be configured as an active and a passive control system. In other words, in some embodiments, control processing may take place on board at the control system 200. In alternative embodiments, the control processing may take place at a location remote to the submersible device 100. The control system 200 may be configured with a receiver (not shown) operable to receive instructions resulting from the processing that took place at the remote location.

The control system 200 may be communicatively coupled to the control fins 112, 114, 108, and 116 and the propeller fins 106 (illustrated in FIG. 3). The control system 200 can send instructions to the control fins 112, 114, 108, and 116 to adjust their orientation, as discussed above. Furthermore, the control system 200 can send instructions to the propeller fins 106 to manipulate the speed/rotation of the propeller fins 106. For example, the control system 200 can manipulate the propeller pitch as necessary to regulate the quantity of power delivered. Furthermore, the control system 200 may manipulate the blades to 0-pitch for transit. The instructions from the control system 200 may be for the purposes of maintaining depth, position and orientation of the submersible device 100.

The ability to operably manipulate the control fins 112, 114, 108, and 116 improves the efficiency of the turbine device 240 through concentration of ocean current flow. The curved leading edges A of the control fins 112, 114, 108, and 116 may be dynamically adapted to guide the ocean current flow along the elongated body of the submersible hull 110 (shown in FIG. 3) towards the propeller fins 106 at the tapered distal end 104, reducing flow separation, turbulence and associated vibrations.

By dynamically adjusting the control fins 112, 114, 108, and 116 and the propeller fins 106, the control system 200 may be configured to nullify torque at the distal end 104 of the submersible hull 110. Furthermore, the control system 200 may also be configured to produce a positive swirl of water at the propeller fins 106, increasing the efficiency of the turbine device 240. The control system 200 may also be configured to cause the submersible hull 110 to move side to side creating a large sway area when submerged, further improving the efficiency of the turbine device 240.

FIG. 5 illustrates an exemplary electrical interconnect system 300, in accordance with an embodiment of the present disclosure. Multiple submersible devices 100 can be submerged within an ocean depth. Oceans' currents flow at all depths, with the strongest usually occurring in the upper layer, which is shallow compared to the depth of the oceans. For the purposes of the illustrated example, the submersible devices 100 are configured as submersible power generators. Each submersible power generator can be submerged at a common depth. In alternative embodiments, the submersible power generators can be submerged at varying depths. Furthermore, each submersible power generator may be positioned at large enough distance away from each other to account for the large sway area.

Each of the submersible power generators can be coupled to a moored station 320. In some embodiments, the moored station 320 may be submerged. In alternative embodiments, the moored station 320 may be located on land or at the ocean surface 305. The moored station 320 is communicatively coupled to an electric grid 400. The submersible power generators may be configured to output electricity to the electrical grid 400 via the interconnect adaptors 120 and the moored station 320.

The disclosed electrical interconnect system 300 benefits from the deep-water currents, which represent a steady source of energy. Furthermore, because the electrical interconnect system 300 includes multiple submersible devices 100, the electrical interconnect system 300 will have little to no impact on the environment. In fact, there is no impact to coastal sight-lines because the electrical interconnect system 300 may be partially or fully submerged below the ocean surface. The electrical interconnect system 300 is unaffected by weather, including hurricanes. Furthermore, the cost and installation are far lower than alternative power generation systems. The electrical interconnect system 300 is also more efficient than traditional green technology, such as solar, on-shore wind, off-shore wind, and tidal energy. Indeed, it is anticipated that the system in accordance with the disclosed principles may experience 86% utilization, which is far greater than solar (20%-25%), on-shore wind (25%-45%), off-shore wind (approximately 45%) and tidal (approximately 50%-60%) systems.

The ocean currents need not be in excessive speeds for maximum efficiency. Water is much denser than air. As a result, the turbines in the submersible device 100 can be up to seventy-percent smaller than power-equivalent wind turbines.

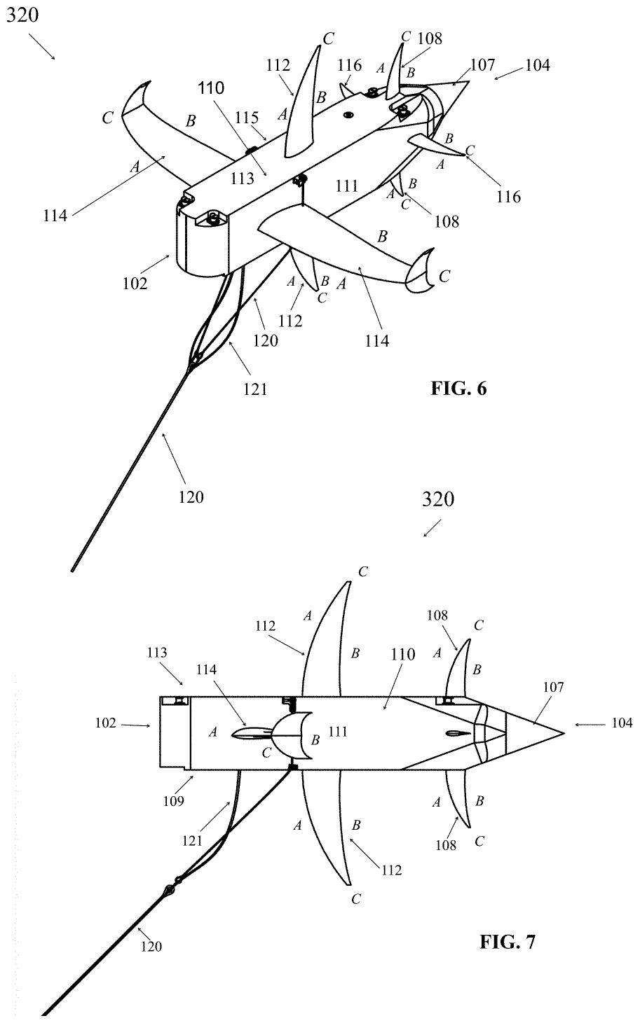

FIG. 6 illustrates an example moored substation 320, in accordance with an embodiment of the present disclosure. FIG. 7 is a side plan view of the moored substation 320. Similar to the submersible device 100, the moored substation 320 may include a proximal end 102 and a distal end 104. The moored substation 320 can also include a submersible hull 110, control fins 112, 114, 108, and 116, fairing 107, sidewalls 109, 111, 113, and 115. The submersible hull 110 may be an elongated structural body, tapering towards the distal end 104 and the fairing 107, for enhanced aerodynamic characteristics.

Unlike the submersible device 100, the moored substation 320 may operate without propellers, because the moored substation 320 may be configured for additional purposes outside of generating energy. The moored substation 320 may be configured to connect multiple field lines received from the submersible device 100 described above, condition the power and then send it to an electrical grid on shore. Unlike traditional wind-farm systems where this equipment would be located above water on a barge, the moored substation 320 is not vulnerable to ocean storms or hurricanes.

The fairing 107 may be designed to be largely rigid and can vibrate, while remaining anchored to the submersible hull 110. The top of the fairing 107 (towards the distal end 104) may be unconstrained. The fairing 107 may be built using resins reinforced with carbon and/or glass fiber. Other materials may be selected and implemented herein. The fairing 107 allows the submersible hull 110 of the moored substation 320 to be sealed and faired. The elongated structural body of the submersible hull 110, tapering towards the distal end 104 and the fairing 107 may enable the moored substation 320 to be able to adapt very quickly to direction changes of the ocean current and turbulent ocean currents.

The control fins can include lateral control fins 114 and 116, and vertical control fins 112 and 108. The lateral control fins 116 and the vertical control fins 108 can be positioned on the submersible hull 110 towards the distal end 104. The lateral control fins 114 and the vertical fins 112 can be positioned on the submersible hull 110 towards the proximal end 102. Each of the lateral control fins 114 and 116 can include a leading-edge A, a trailing edge B, and a wingtip C adjoining the leading-edge A and the trailing edge B. The wingtip C may be configured with a variety of shapes and designs. For example, the wingtip C may include winglets, as illustrated herein. Winglets may be implemented to reduce drag from wingtip vortices. Other shapes may include, but are not limited to square-off, aluminum tube bow, rounded, Hoerner style, dropped tips, raked wingtips, sails, fences, and end plates.

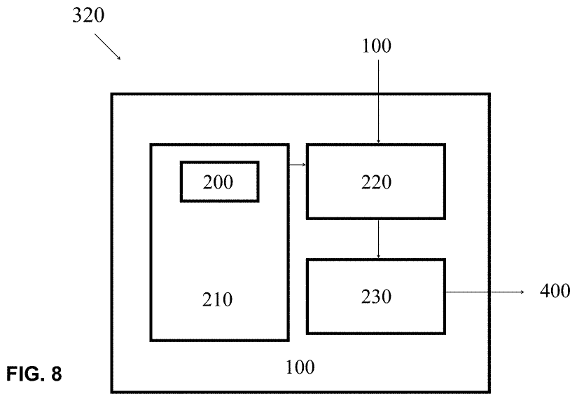

FIG. 8 is a block diagram illustrating example components of the moored substation 320, in accordance with an embodiment of the present disclosure. The moored substation 320 may include a wet room 210, an electrical housing 220 for electrical cable connections, and a power conditioning device 230.

The moored substation 320 may be configured to connect multiple field lines received from the submersible device 100 described above. The power received from the multiple field lines may be conditioned at the power conditioner device 230 and sent it to an electrical grid 400 on shore. Unlike traditional wind-farm systems where this equipment would be located above water on a barge, the moored substation 320 is not vulnerable to ocean storms or hurricanes. The wet room 210 can house a control system 200. The control system 200 and other electrical components within the wet room 210 can be electrically coupled to the electrical housing 220.

The control system 200 can be configured as an active and a passive control system. In other words, in some embodiments, control processing may take place on board at the control system 200. In alternative embodiments, the control processing may take place at a location remote to the moored substation 320. The control system 200 may be configured with a receiver (not shown) operable to receive instructions resulting from the processing that took place at the remote location.

The control system 200 may be communicatively coupled to the control fins 112, 114, 108, and 116 (illustrated in FIGS. 6 and 7). The control system 200 can send instructions to the control fins 112, 114, 108, and 116 to adjust their orientation, as discussed above. For example, the control system 200 may manipulate the blades to 0-pitch for transit. The instructions from the control system 200 may be for the purposes of maintaining depth, position and orientation of the moored substation 320.

The ability to operably manipulate the control fins 112, 114, 108, and 116 improves the operability of the moored substation 320 through concentration of ocean current flow. The curved leading edges A of the control fins 112, 114, 108, and 116 may be dynamically adapted to guide the ocean current flow along the elongated body of the submersible hull 110 (shown in FIG. 7), reducing flow separation, turbulence and associated vibrations.

By dynamically adjusting the control fins 112, 114, 108, and 116, the control system 200 may be configured to nullify torque at the distal end 104 of the submersible hull 110. The control system 200 may also be configured to manipulate the plurality of control fins to cause the submersible hull 110 to move side to side creating a large sway area when submerged.

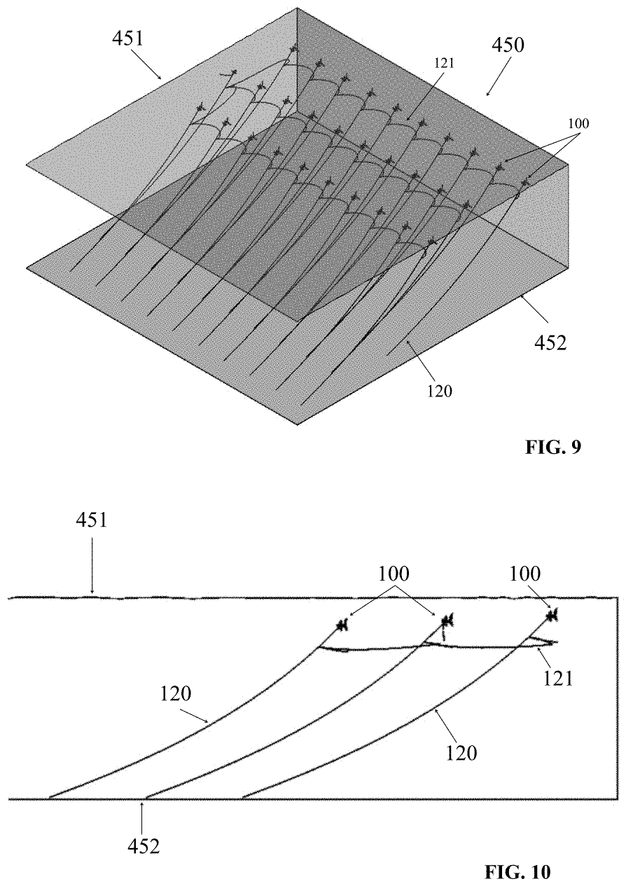

FIG. 9 illustrates more than one submersible device 100 in an ocean environment 450, in accordance with an embodiment of the present disclosure. FIG. 10 illustrates a side plan view of the ocean environment 450, in accordance with an embodiment of the present disclosure. The submersible device 100 may be secured to the ocean subsurface 452, or to another device (e.g., moored substation 320) beneath the submersible device 100 by a tethering device 120. The submersible device 100 may be configured to output electricity to an electrical grid (not shown) via an interconnect adaptor 121, partially running along the tethering device 120.

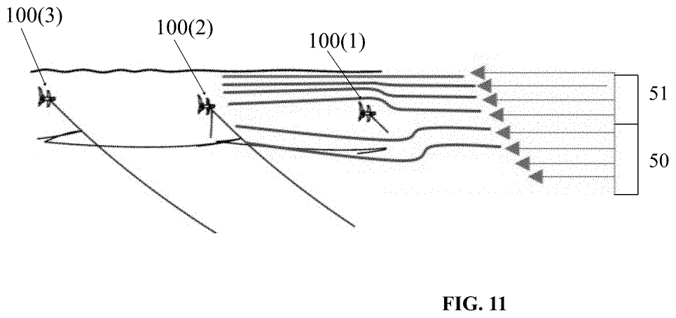

FIG. 11 illustrates ocean current flow approaching three rows of submersible devices, in accordance with an embodiment of the present disclosure. A first row of submersible devices 100(1) is followed by a second row of submersible devices 100(2), which is followed by a third row of submersible devices 100(3). Propellers of each of the submersible devices tend to create a disturbance of downstream ocean current. As a result, the submersible devices may be distanced from each other to account for the disturbance. However, the moored substation 320 does not produce such disturbance due to the bladeless design. As a result, any limitation associated with the “wake effect” is avoided. The submersible devices 100 may have a 59% theoretical efficiency, indicating up to 41% of the fluid will go around the blades rather than through them. The three-dimensional position of the submersible devices can be optimized to maximize efficiency. As illustrated in FIG. 11, a first portion 51 of the ocean current flow may be trapped above the first row of submersible device 100(1). By staggering the second 100(2) and third row of submersible devices 100(3) in less depth than the first row of submersible devices 100(1), the first portion 51 of the ocean currents can be utilized, improving efficiency of the second 100(2) and third row of submersible devices 100(3). Similarly, a second portion 50 of the ocean current flow may be trapped below the first row of submersible device 100(1). By staggering subsequent rows of submersible devices in greater depth than the first row of submersible devices 100(1), the second portion 50 of the ocean currents can be utilized, improving efficiency of the subsequent rows of submersible devices.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A submersible device comprising:
a submersible hull with a proximal end, an opposing distal end, a first sidewall and a second sidewall opposite the first sidewall, said sidewalls being between the proximal and distal ends of the hull;
a plurality of control fins extending from the submersible hull, at least one control fin extending from the first sidewall and at least one other control fin extending from the second sidewall;
a plurality of propeller fins extending from the submersible hull at the distal end, each of the propeller fins being connected to a rotor; and
a turbine device communicatively coupled to the rotor.

2. The submersible device of claim 1, wherein the turbine device is configured to generate electricity due to rotation of the plurality of propeller fins.

3. The submersible device of claim 2, further comprising a power conditioning device communicatively coupled to the turbine device and electrically connected to an electric grid,
wherein the power conditioning device is configured to output the electricity to the electrical grid via an interconnect adaptor, the interconnect adaptor being closer to the proximal end than the distal end.

4. The submersible device of claim 1, wherein the rotation of the plurality of propeller fins corresponds with motion of ocean currents.

5. The submersible device of claim 1, further comprising an active and passive control system communicatively coupled to the plurality of control fins and the plurality of propeller fins to maintain depth, position and orientation of the submersible hull.

6. The submersible device of claim 5, wherein the active and passive control system is configured to nullify torque at the distal end of the submersible hull and to produce a positive swirl of water at the plurality of propeller fins.

7. The submersible device of claim 5, wherein the active and passive control system is configured to cause the submersible hull to move side to side creating a large sway area.

8. The submersible device of claim 1, wherein each propeller of the plurality of propeller fins is foldable.

9. The submersible device of claim 1, wherein an internal volume of the submersible hull is pressure compensated at a controlled pressure other than ambient pressure.

10. A system comprising:
a moored substation;
two or more submersible power generators electrically coupled to the moored substation, each submersible power generator comprising:
a submersible hull with a proximal end, an opposing distal end, a first sidewall and a second sidewall opposite the first sidewall, said sidewalls being between the proximal and distal ends of the hull;
a plurality of control fins extending from the submersible hull, at least one control fin extending from the first sidewall and at least one other control fin extending from the second sidewall;
a plurality of propeller fins extending from the submersible hull at the distal end, each of the propeller fins being connected to a rotor;
a turbine device communicatively coupled to the rotor; and
a power conditioning device communicatively coupled to the turbine device and electrically connected to moored substation.

11. The system of claim 10, wherein the turbine device is configured to generate electricity due to rotation of the plurality of propeller fins.

12. The system of claim 11, wherein the power conditioning device is configured to output the electricity to the electrical grid via an interconnect adaptor, the interconnect adaptor is closer to the proximal end than the distal end.

13. The system of claim 10, wherein the rotation of the plurality of propeller fins corresponds with motion of ocean currents.

14. The system of claim 13, further comprising an active and passive control system communicatively coupled to the plurality of control fins and the plurality of propeller fins to maintain depth, position and orientation of the submersible hull.

15. The system of claim 13, wherein the plurality of active and passive control system is configured to nullify torque at the distal end of the submersible hull to produce a positive swirl of water into the turbine device.

16. The system of claim 13, wherein the plurality of active and passive control system is configured to cause the submersible hull to move side to side creating a large sway area.

17. The system of claim 10, wherein each propeller of the plurality of propeller fins is foldable.

18. The system of claim 10, wherein an internal volume of the submersible hull is pressure compensated at a controlled pressure other than ambient pressure.

19. A moored substation comprising:
a submersible hull with a proximal end, an opposing distal end, a first sidewall and a second sidewall opposite the first sidewall, said sidewalls being between the proximal and distal ends of the hull;
a plurality of control fins extending from the submersible hull, at least one control fin extending from the first sidewall and at least one other control fin extending from the second sidewall;
a power conditioner device configured to receive power from at least one submersible power generator and output the electricity to an electrical grid; and
a fairing extending from the submersible hull at the distal end.

20. A system comprising:
a first plurality of submersible power generators arranged in a first row and positioned at a first depth; and
a second plurality of submersible power generators arranged in a second row positioned at a second depth behind the first plurality of submersible power generators, the second depth is different from the first depth.
